(19) United States
(12) Patent Application Publication
(10) Pub. No.: US 2012/0092269 A1
(43) Pub. Date: Apr. 19, 2012

(54) COMPUTER-IMPLEMENTED METHOD FOR MANIPULATING ONSCREEN DATA

(75) Inventors: PEI-YUN TSAI, Tu-Cheng (TW); MIKE WEN-HSING CHIANG, Santa Clara, CA (US)

(73) Assignee: HON HAI PRECISION INDUSTRY CO., LTD., Tu-Cheng (TW)

(21) Appl. No.: 12/905,960

(22) Filed: Oct. 15, 2010

(51) Int. Cl. G06F 3/041

(52) U.S. Cl. 345/173

(57) ABSTRACT

A computer-implemented method for operating content of an electronic device is disclosed. The method includes displaying content on a touch-sensitive display. A touch path is received from the display. A selection path and a command initiation path from the touch path are identified. Operating content from the associated file with a selection path is selected. A command mode is entered according to the command initiation path.

### CROSS-REFERENCE TO RELATED APPLICATIONS

Relevant subject matter is disclosed in co-pending U.S. Patent Applications entitled “COMPUTER-IMPLEMENTED METHOD FOR MANIPULATING ONSCREEN DATA”, Attorney Docket Number U.S.34900, U.S. application Ser. No. ______, Filed on ______.

### BACKGROUND

1. Technical Field

The present disclosure relates to a computer-implemented method for manipulating onscreen data.

2. Description of Related Art

Electronic devices, such as e-books, allow users to input content. The users can input the content using a stylus or a finger if the electronic device is touch-sensitive. If the user wants to manipulate (e.g. copy/paste) on screen content, the content must first be selected. For some electronic devices, the user may need to drag a frame to select the content. Then the user selects the desired content. However, it is not convenient for the user to select the content.

### BRIEF DESCRIPTION OF THE DRAWINGS

FIG. 1 is a block diagram of an embodiment of a system for manipulating onscreen data.

FIG. 2 shows a schematic view of selecting a sentence.

FIG. 3 shows a schematic view of the selected sentence in broken lines.

FIG. 4 shows a schematic view of selecting a paragraph with a frame.

FIG. 5 shows a schematic view of selecting a picture with a frame.

FIG. 6 shows a schematic view of selecting a paragraph with a loop.

FIG. 7 shows a schematic view of selecting a picture with a loop.

FIG. 8 shows a schematic view of selecting a paragraph with a freestyle shape.

FIG. 9 shows a schematic view of selecting some words with a freestyle shape.

FIG. 10 shows a schematic view of selecting several pictures with a freestyle shape.

FIG. 11 shows a schematic view of selecting words and pictures with a freestyle shape.

FIGS. 12A-12B show schematic views of selecting a paragraph with a line.

FIGS. 13A-13B show schematic views of selecting a picture with a line.

FIGS. 14A-14B show schematic views of selecting a paragraph with a square bracket.

FIGS. 15A-15B show schematic views of selecting a paragraph with two square brackets.

FIGS. 16A-16B show a schematic views of selecting a picture and words with two square brackets.

FIGS. 17A-17B show a schematic views of selecting a paragraph with four corner shapes.

FIGS. 18A-18B show schematic views of selecting a paragraph with two corner shapes.

FIGS. 19A-19B shows schematic views of selecting a picture, words, or handwriting ink with two corner shapes.

FIG. 20 shows a schematic view of selecting a word.

FIG. 21 shows a schematic view of selecting some words.

FIG. 22 shows a schematic view of selecting a file.

FIG. 23 shows a schematic view of selecting a triangle.

FIG. 24 shows a flowchart of the method for manipulating onscreen data.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming languages such as Java, C, or Assembly. One or more software instructions in the modules may be embedded in firmware, such as an EPROM. It is noteworthy, that modules may comprise connected logic units, such as gates and flip-flops, and programmable units such as programmable gate arrays or processors. The modules described herein may be implemented as software and/or hardware modules and may be stored in any type of computer-readable medium or other computer storage device.

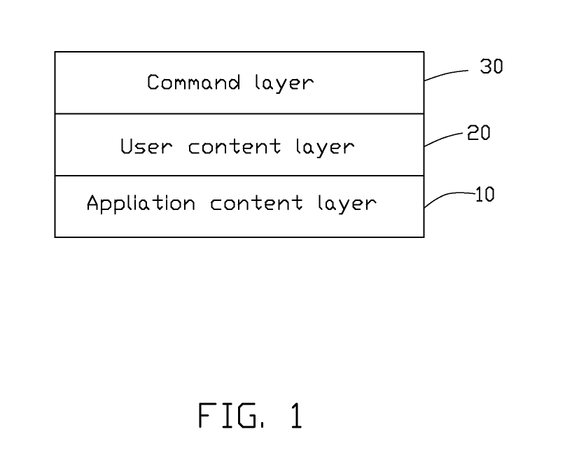

Referring to FIG. 1, a system for manipulating onscreen data includes an application content module 10, a user content module 20, and a command module 30. The system can be used to facilitate user interaction with onscreen data, an electronic device installed with the system, and/or applications installed in the electronic device. Such interaction may include, among other operations, word processing, text editing, image labeling and editing, mode selection, and menu item selection. The interaction is accomplished through touch input by a user on a touch sensitive screen of the electronic device. Touch input can be performed either by finger touch, stylus, or other suitable implement, and the user content module will cause corresponding line or marks to appear onscreen corresponding to the path of the touch input. The application content module 10 is an interface in communication with applications of the electronic device (e.g. a road map application and an e-book reader application) which allows user interaction with and manipulation of application data on display. The user content module 20 receives and allows manipulation of user input displayed onscreen. When the user reads e-books, the user may input text and/or marks related to the e-book text, and edit the text and/or marks, by touch. The command module 30 is an interface used for entering or changing command modes of the system. In one such command mode, user input is recognized by the application content module 10 and/or the user content module 20, and in response an operation, (e.g. selection and copying of content) is performed. In one embodiment, the user may select text which is copied to a clipboard of the device and can then be pasted into content of another application, such as in a letter of an email application.

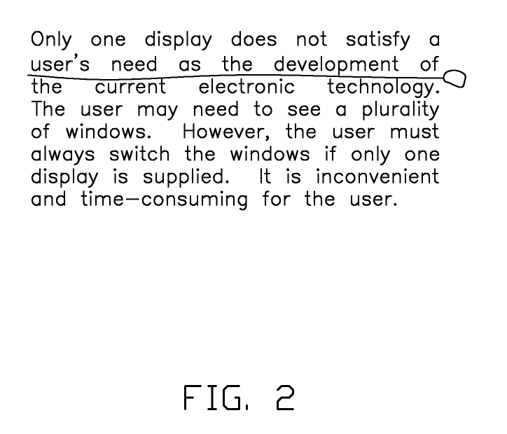

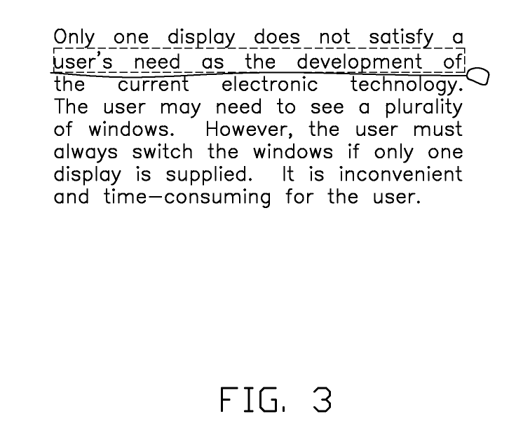

Referring to FIGS. 2-3, user input is illustrated. The user draws a line (selection path) by touch under a sentence in one embodiment and then finishes the line drawing movement (completes the touch path) by drawing a roughly circular shape without break. When the user draws a circle or an approximation of a circle (command initiation path) at an end of the line, the system enters the command mode. The circle will not be completed every time. It should recognize the circular pattern, even if it is not even it does not form a completed circle. In this particular example, the command mode allows, among other things, the recognition of touch path immediately preceding the drawing of the circle to be a selection command. Thus, at this time, the sentence underscored by the drawn line is selected. Further, the user can enter the command mode using the same method in any application within the system. A command menu is generated near the command initiation path to display at least one command operation to operating content.

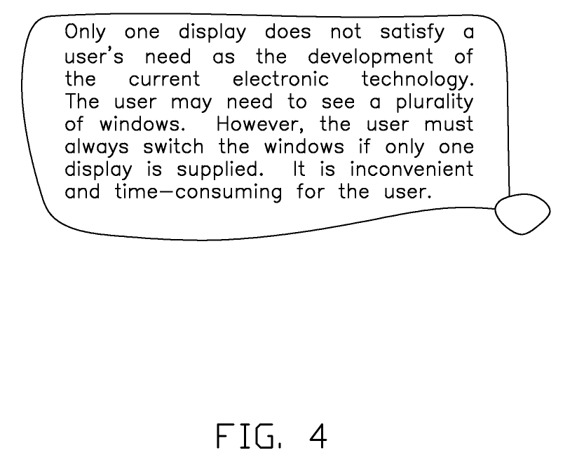

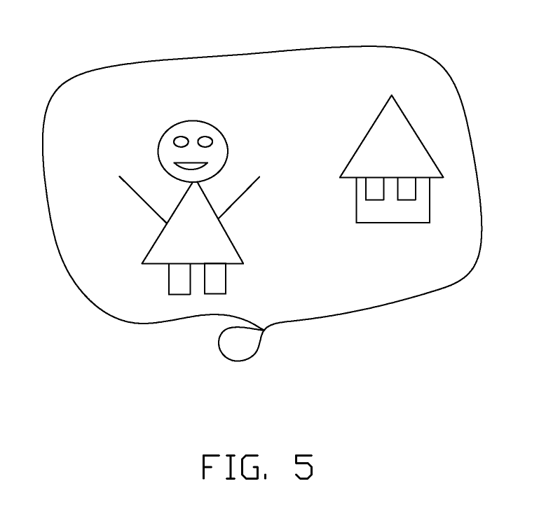

Referring to FIGS. 4 and 5, the user can draw a frame around the content. The user draws the circle to start the command mode. The user can then manipulate onscreen content, and perform actions such as copy/cut.

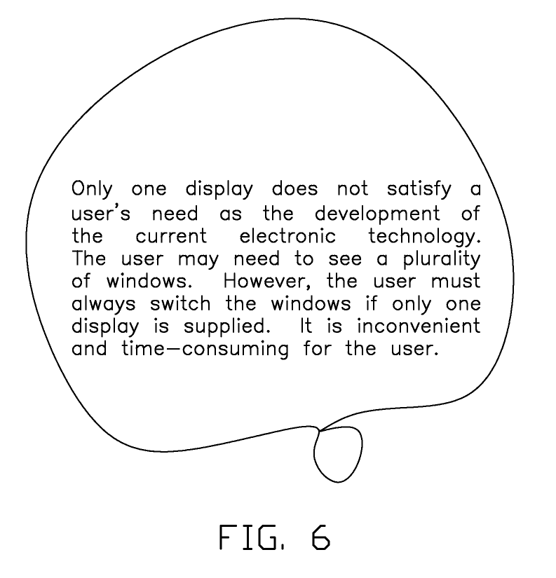

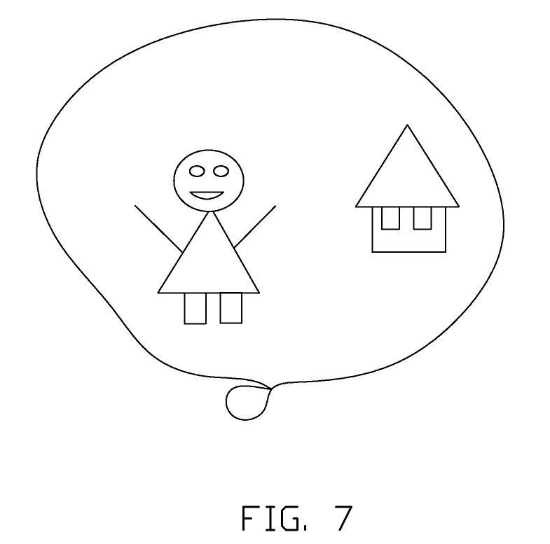

Referring to FIGS. 6 and 7, the user can directly draw a loop to enclose the content. The user draws the circle to start the command mode. The user can then manipulate onscreen content, and perform actions such as copy/cut.

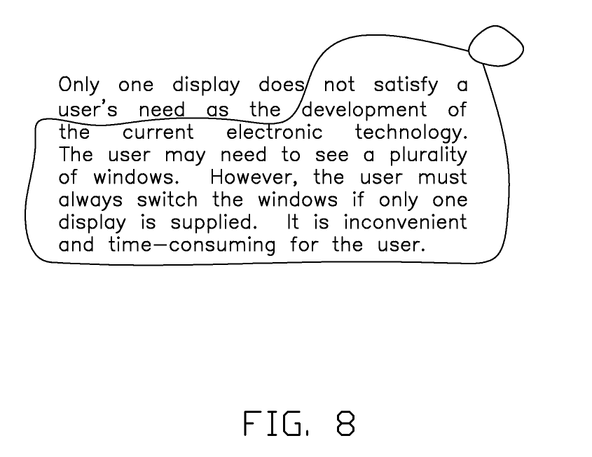

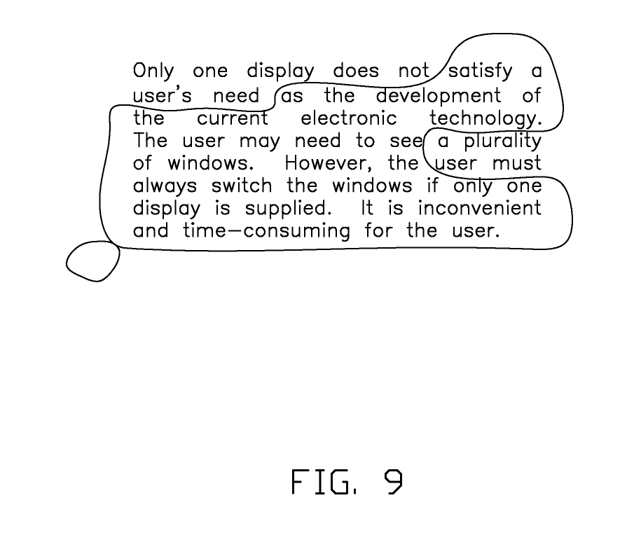

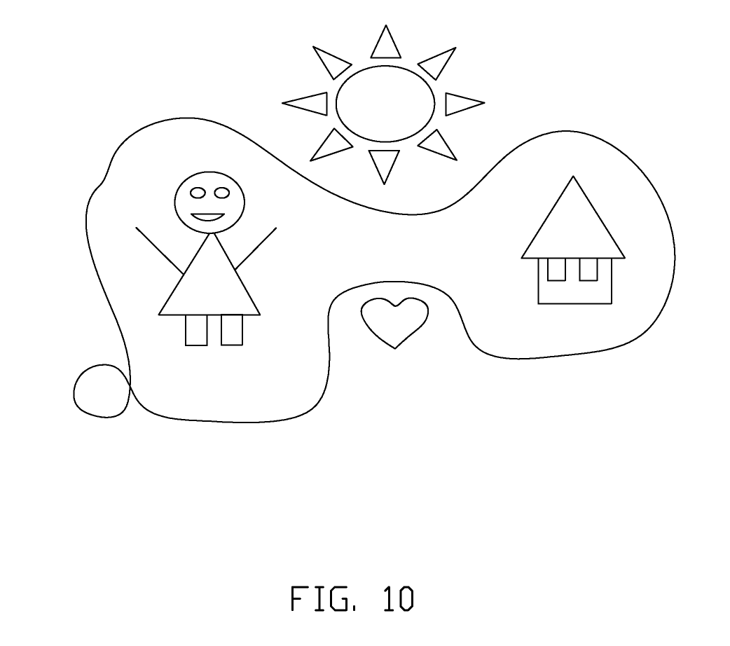

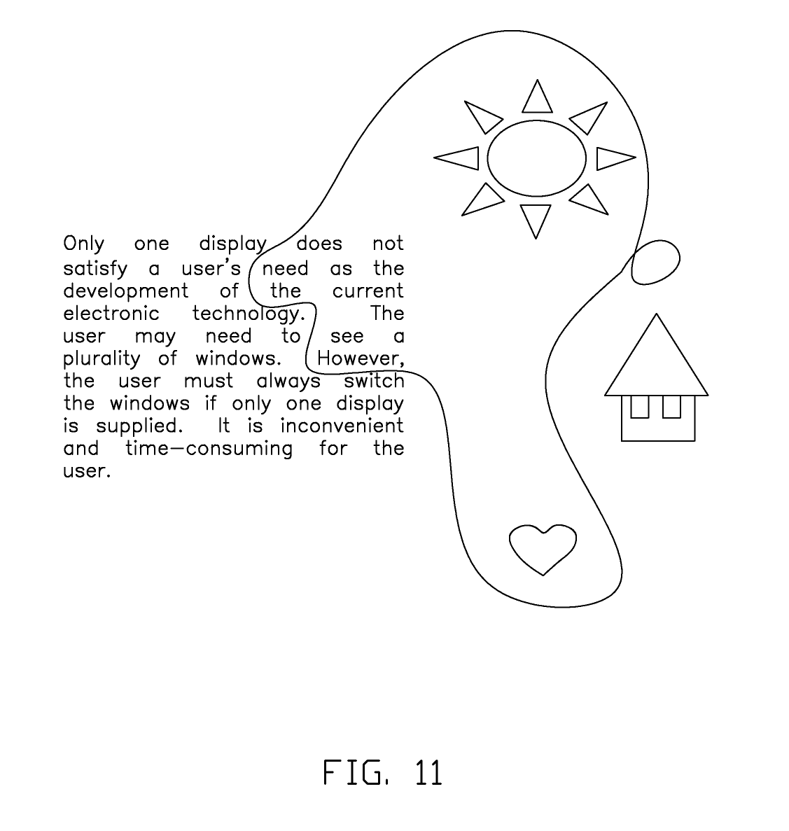

Referring to FIGS. 8-11, the user can directly draw a freestyle shape to enclose the content. The user draws the circle to start the command mode. The user can then manipulate onscreen content, and perform actions such as copy/cut.

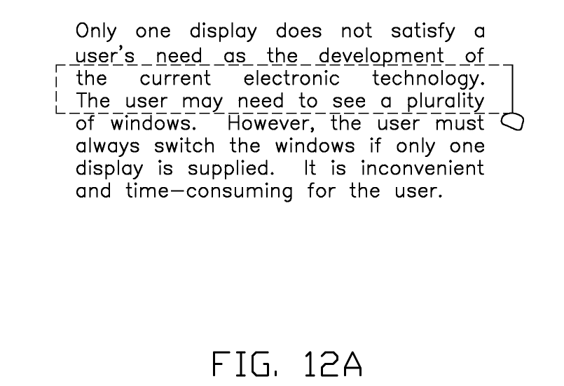

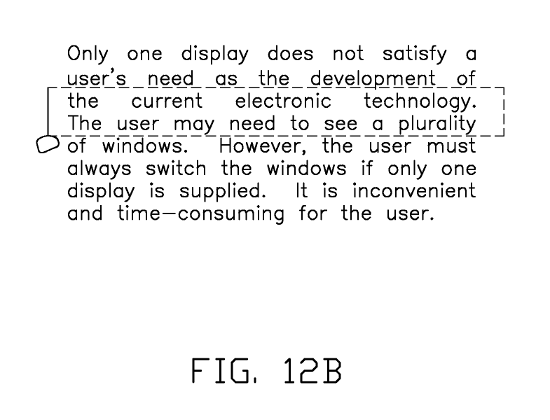

Referring to FIGS. 12A and 12B, for selecting a large area, the user can directly draw a line in a blank area to select the more content. For a text, a plurality of lines of the content may be selected. The user draws the circle to start the command mode. The user can then manipulate onscreen content, and perform actions such as copy/cut.

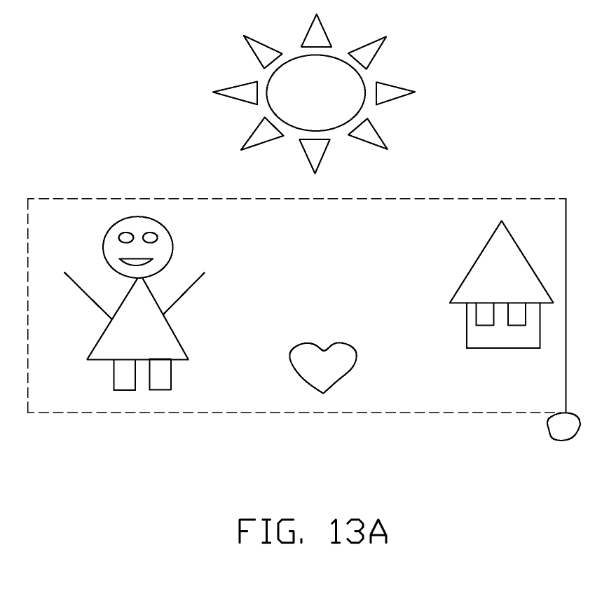

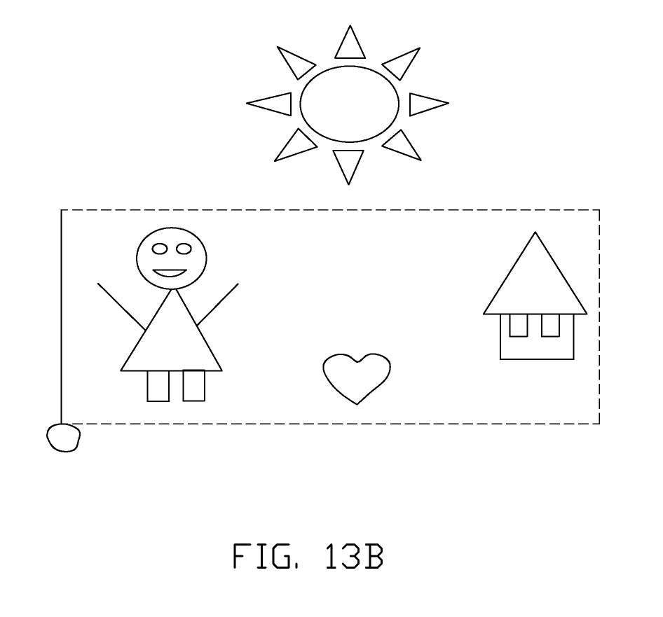

Referring to FIGS. 13A and 13B, for selecting a large area, the user can directly draw a line in a blank area to select more content. For a picture, a length of the line is basically equal to a height of the picture. The user draws the circle to start the command mode. The user can then manipulate onscreen content, and perform actions such as copy/cut.

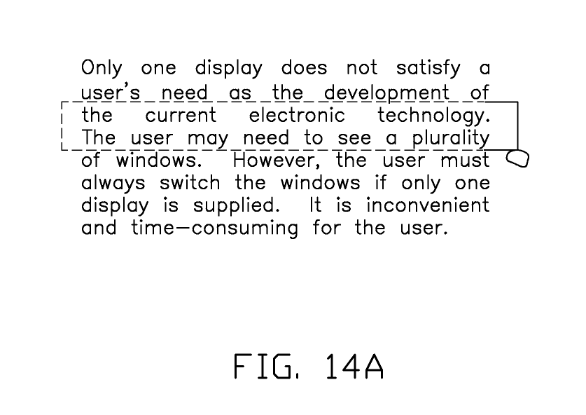

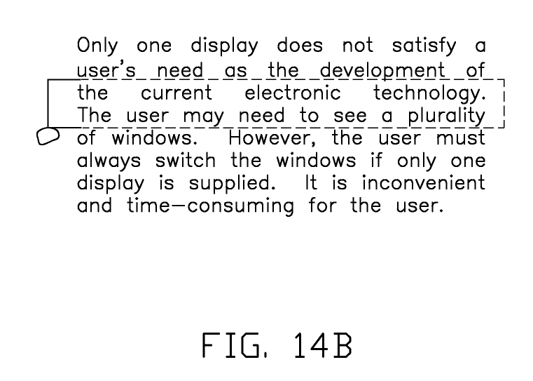

Referring to FIGS. 14A and 14B, for selecting a large area, the user can directly draw a square bracket in a blank area to select the content. For a text, the rows of the content in the square bracket are selected. The user draws the circle to start the command mode. The user can then manipulate onscreen content, and perform actions such as copy/cut.

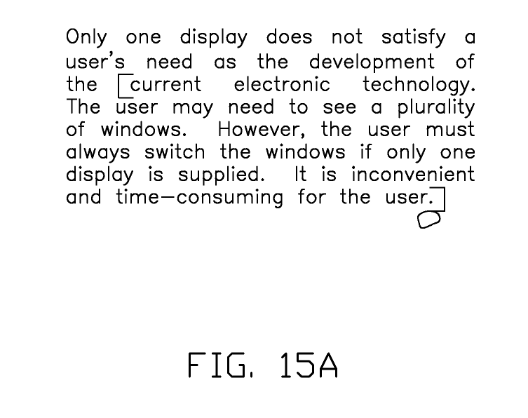

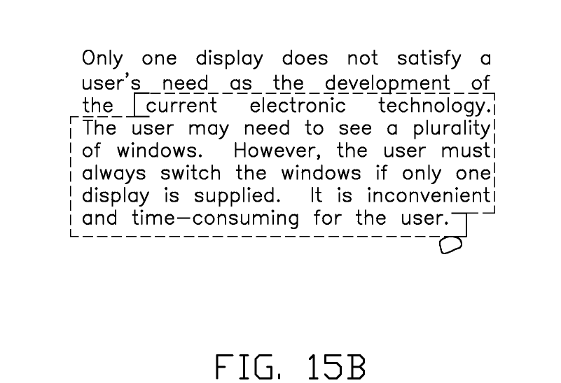

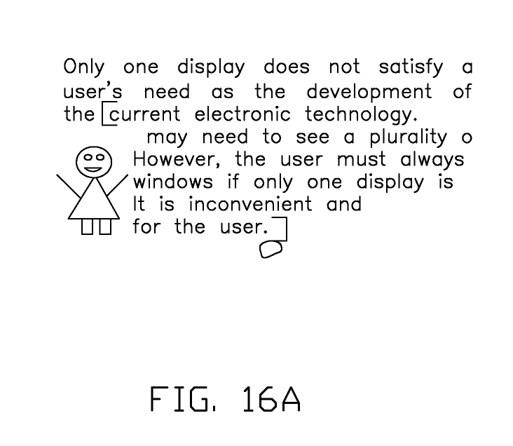

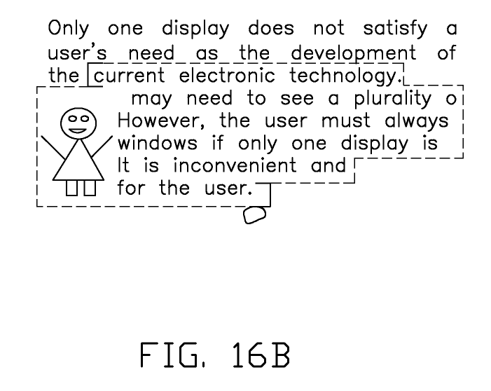

Referring to FIGS. 15A-15B and 16A-16B, for selecting a large area, the user can directly draw square brackets in a start position and an end position to select needed objects of content. Each object may be a word, a picture, a handwriting ink, or an icon etc. In one embodiment, the system can recognize the selection content in two alternative working modes. First, in a position mode, each object in an area between the square brackets is selected. Second, in an input sequence mode, the input sequence/time of each object of the content is recorded in the system. Each object with the input sequence/time between an input sequence/time of a first object embraced or crossed by the start square bracket and an input sequence/time of a last object embraced or crossed by the last square bracket is selected. The user draws the circle to start the command mode. The user can then manipulate onscreen content, and perform actions such as copy/cut.

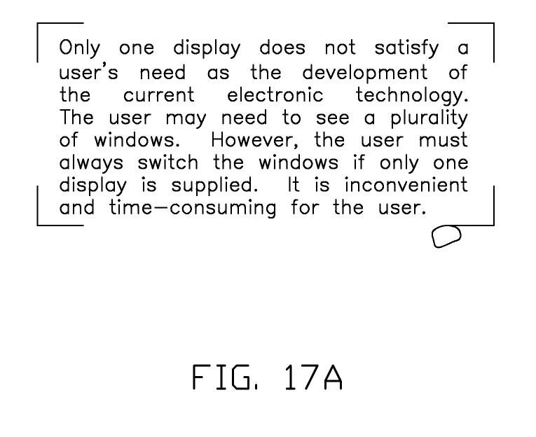

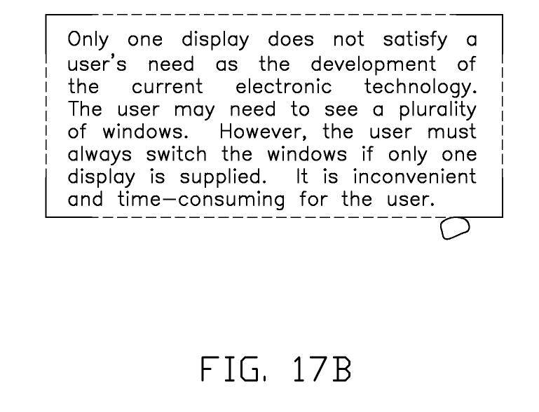

Referring to FIGS. 17A and 17B, for selecting a large area, the user can directly draw a corner shape in a corner area to select more content. For a text or a picture, the content within the corner shapes is selected. Finally, the user draws the circle to start the command mode. The user can then manipulate onscreen content, and perform actions such as copy/cut.

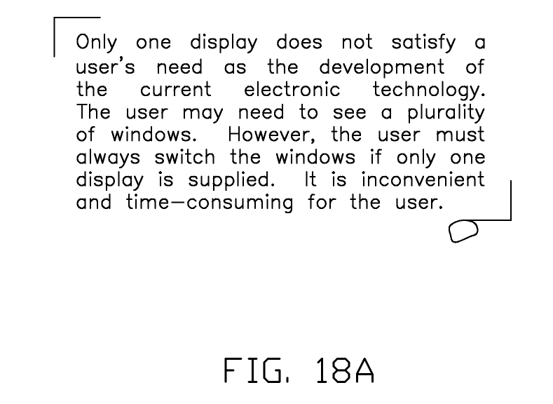

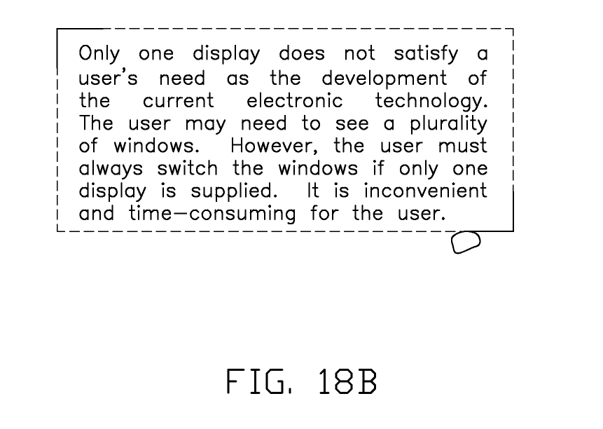

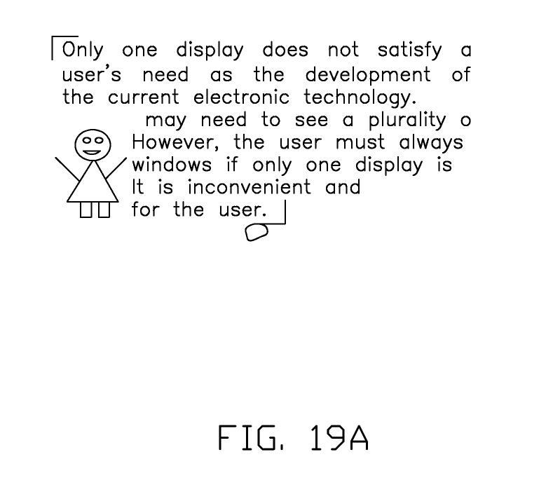

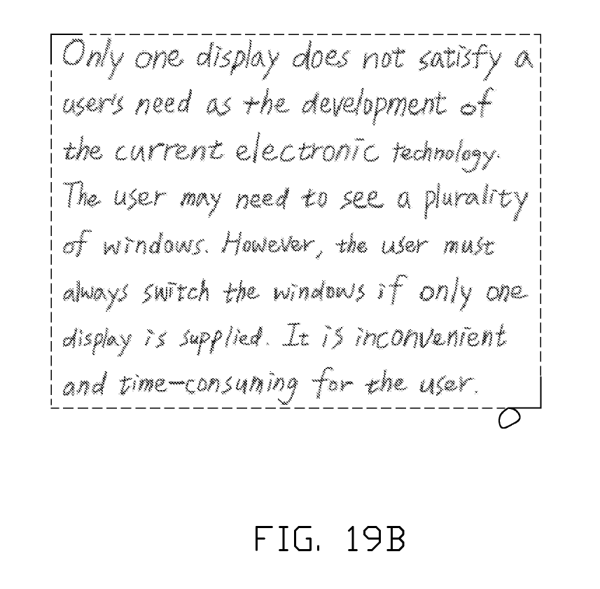

Referring to FIGS. 18A-18B and 19A-19B, for selecting a large area, the user can similarly draw a corner shape in a start corner place and an end corner place to select more content. For a text, handwriting ink, or a picture, the content in the corner shape is selected. The user draws the circle to start the command mode. The user can then manipulate onscreen content, and perform actions such as copy/cut.

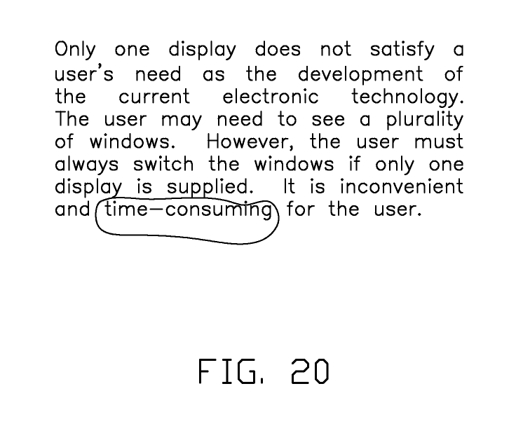

Referring to FIG. 20, the system can automatically identify a whole selected area as “time-consuming” even if a dot at the top of a letter “i” outside the loop. The user draws the loop to enclose the area with the “time-consuming” option, but inadvertently misses a dot at the top of a letter “i” outside the loop. However, the system identifies the “time-consuming” option and because the dot is very close to the “time-consuming” content in the loop and recognizes that the dot of the “i” is part of the “time-consuming” option.

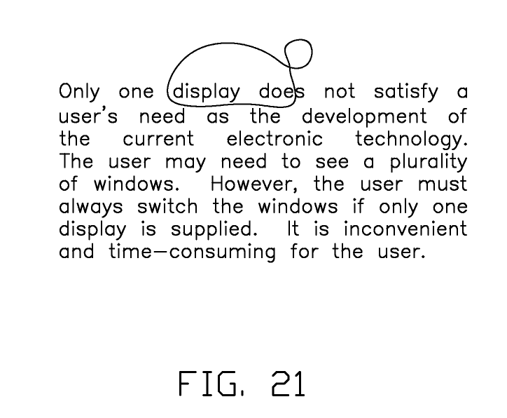

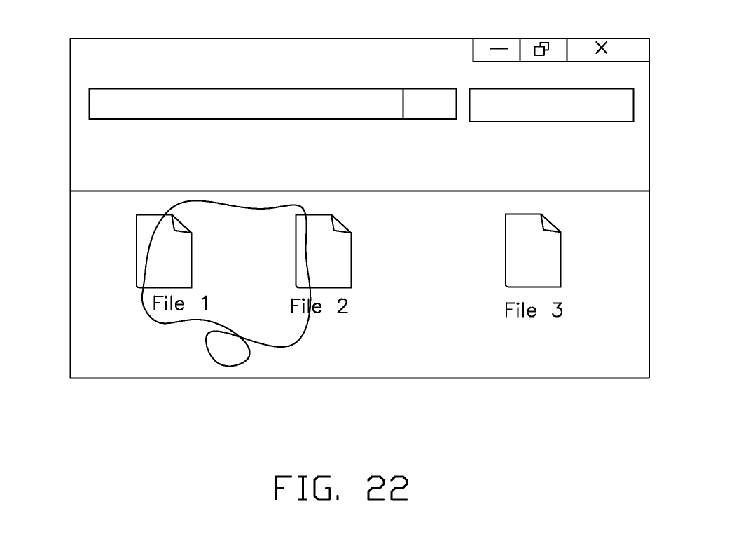

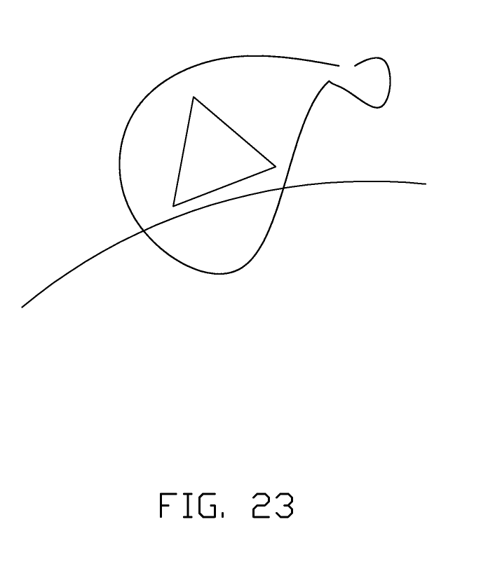

Referring to FIGS. 21-23, When one object is enclosed beyond a predetermined percent, for example, 50 percent of the object is enclosed, the system may identify the object as selected. FIG. 21 shows “display does” is selected. FIG. 22 shows the icon of File 1 is selected but File 2 is not selected. FIG. 23 shows the triangle is selected, but an arc line is not selected.

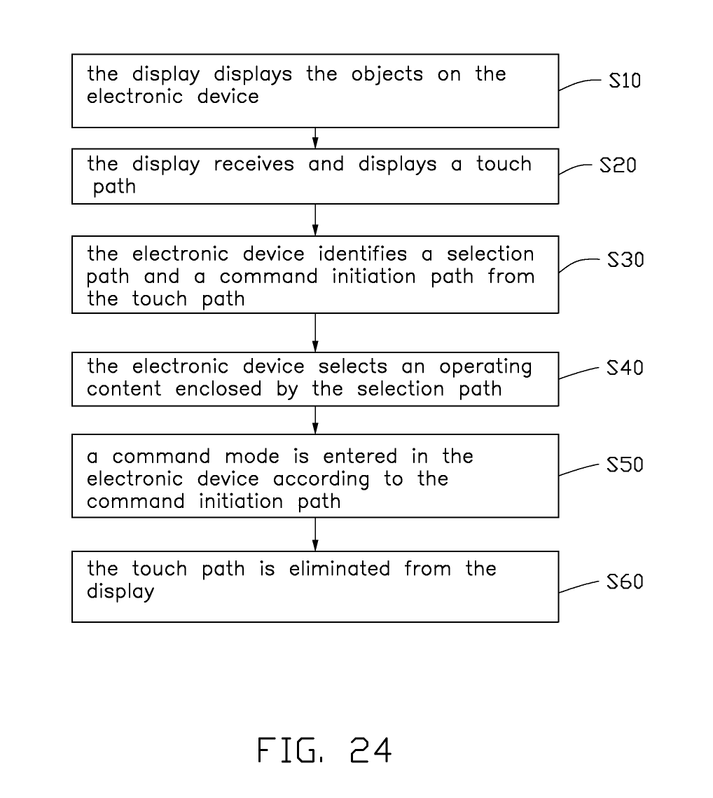

Referring to FIG. 24, one embodiment of a computer-implemented method for manipulating onscreen data includes the following blocks.

In block S10, the display displays the objects on the electronic device.

In block S20, the display receives and displays a touch path.

In block S30, the electronic device identifies a selection path and a command initiation path from the touch path.

In block S40, the electronic device selects an operating content enclosed by the selection path.

In block S50, a command mode is entered in the electronic device according to the command initiation path.

In block S60, the touch path is eliminated from the display.

While the present disclosure has been illustrated by the description of the embodiments thereof, and while the embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

Depending on the embodiment, certain steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A computer-implement method for manipulating onscreen data, comprising:
displaying content on a touch-sensitive display;
receiving a touch path from the display;
identifying a selection path and a command initiation path from the touch path;
selecting operating content from the content associated with the selection path; and
entering a command mode according to the command initiation path.

2. The method of claim 1, wherein the selection path comprises a line under the operating content.

3. The method of claim 1, wherein the selection path comprises a frame around the operating content.

4. The method of claim 1, wherein the selection path comprises a loop to enclose the operating content.

5. The method of claim 4, wherein the loop is unsymmetrical.

6. The method of claim 1, wherein the selection path comprises a line adjacent to the operating content, a height of the line is substantially equal to a height of the operating content.

7. The method of claim 1, wherein the selection path comprises square brackets, the operating content is in an area between the square brackets.

8. The method of claim 1, wherein the selection path comprises two square brackets, the content comprises a plurality of objects, an input time of each of the plurality of objects is recorded, the operating content comprises objects with the input times between an input time of a first object embraced or crossed by a start square bracket of the two square brackets and an input time of a last object embraced or crossed by a last square bracket of the square bracket.

9. The method of claim 1, wherein the selection path comprises corner shapes positioned at corners of the operating content, and the operating content is enclosed by the corner shapes.

10. The method of claim 1, wherein the selection path comprises corner shapes positioned at a start point and an end point.

11. A computer-implement method for manipulating onscreen data, comprising:
displaying content on a touch-sensitive display;
detecting a touch path from the display;
identifying a selection path and a command initiation path from the touch path;
selecting operating content from the content associated with the selection path; and
generating a command menu near the command initiation path to display at least one command operation.

12. The method of claim 11, wherein the selection path comprises a line under the operating content.

13. The method of claim 11, wherein the selection path comprises a frame around the operating content.

14. The method of claim 11, wherein the selection path comprises a loop to enclose the operating content.

15. The method of claim 14, wherein the loop is unsymmetrical.

16. The method of claim 11, wherein the selection path comprises a line adjacent to the operating content, and a height of the line is equal to a height of the operating content.

17. The method of claim 11, wherein the selection path comprises square brackets, and the operating content is in an area between the square brackets.

18. The method of claim 11, wherein the selection path comprises two square brackets, the content comprises a plurality of objects, an input time of each of the plurality of objects is recorded, the operating content comprises objects with the input times between an input time of a first object embraced or crossed by a start square bracket of the two square brackets and an input time of a last object embraced or crossed by a last square bracket of the square bracket.

19. The method of claim 11, wherein the selection path comprises corner shapes positioned at corners of the operating content, and the operating content are enclosed by the corner shapes.

20. The method of claim 11, wherein the selection path comprises corner shapes positioned at a start point and an end point.
